(19) United States
(12) Patent Application Publication
(10) Pub. No.: US 2026/0158443 A1
(43) Pub. Date: Jun. 11, 2026

(54) SOLID-STATE MEMBRANE FOR SELECTIVE CAPTURE OF CARBON DIOXIDE

(71) Applicant: Valero Services, Inc., San Antonio, TX (US)

(72) Inventors: Jason Daniel Herrera, San Antonio, TX (US); Michael J. Rubal, Lytle, TX (US)

(73) Assignee: Valero Services, Inc., San Antonio, TX (US)

(21) Appl. No.: 19/384,670

(22) Filed: Nov. 10, 2025

Related U.S. Application Data
(60) Provisional application No. 63/730,241, filed on Dec. 10, 2024.

(51) Int. Cl. B01D 53/62; B01D 53/22; B01D 53/82; B01D 67/00; B01D 71/02; B01J 20/06; B01J 20/28; B01J 20/30

(52) U.S. Cl. CPC B01D 53/62; B01D 53/228; B01D 53/82; B01D 67/0044; B01D 71/024; B01J 20/06; B01J 20/28033; B01J 20/3078; B01J 20/3085; B01D 2257/504

(57) ABSTRACT

The present disclosure provides methods and compositions for manufacturing solid-state zirconate membranes for selective carbon dioxide separation from high-temperature gas effluents. A first method involves applying a metal carbonate suspension to a porous zirconia substrate, followed by calcination. A second method involves saturating a porous zirconia substrate with metal hydroxides, converting the hydroxides to carbonates through carbon dioxide exposure, and subsequent calcination. Both methods produce mechanically robust membranes suitable for industrial and vehicle carbon dioxide separation applications. The methods utilize combinations of lithium and other metals, such as potassium, as the metal components, with specific molar ratios optimized for membrane performance. The resulting membranes exhibit improved mechanical stability while maintaining high carbon dioxide selectivity.

### CROSS-REFERENCE TO RELATED APPLICATIONS

This application claims priority to U.S. Provisional Patent Application No. 63/730,241, filed Dec. 10, 2024, the content of which is incorporated herein by reference in its entirety.

### FIELD

The present disclosure relates generally to methods for manufacturing solid-state membranes for gas separation. More particularly, the disclosure relates to methods for producing solid-state zirconate membranes for selective separation of carbon dioxide from high-temperature gas effluents.

### BACKGROUND

Carbon dioxide (CO₂) separation from industrial or vehicle exhaust gas streams is becoming increasingly important for addressing climate change and meeting environmental regulations. Lithium zirconate (Li₂ZrO₃), commonly referred to as LZO, has emerged as a promising material for high-temperature CO₂ separation due to its selective absorption properties. Unlike conventional amine-based absorption methods, LZO operates effectively at elevated temperatures, making it particularly suitable for direct treatment of hot industrial or vehicle effluents.

LZO functions through a chemisorption equilibrium reaction with CO₂, forming lithium carbonate (Li₂CO₃) and zirconia (ZrO₂). This reaction is selective for CO₂ over other gas species, which are only weakly physiosorbed. The temperature-dependent nature of this reaction allows for controlled regeneration and release of captured CO₂.

However, practical implementation of LZO membranes has been hindered by several material challenges. Pure LZO membranes typically exhibit poor mechanical properties, including inadequate cohesion and low fracture toughness. Additionally, these membranes often suffer from dimensional instability during CO₂ absorption-desorption cycles and thermal cycling. These limitations have prevented widespread industrial adoption of LZO-based separation technology.

Therefore, there exists a need for improved methods and compositions for solid-state zirconate membranes for selective separation of carbon dioxide from high-temperature gas effluents.

### BRIEF SUMMARY

Accordingly, the present disclosure addresses this need by methods and compositions for manufacturing solid-state zirconate membranes with enhanced mechanical properties and carbon capture performance characteristics. Two manufacturing approaches may be used: a carbonate slurry method and a hydroxide solution method.

First provided is a carbonate slurry method for producing a solid-state zirconate membrane for selective carbon dioxide separation from high-temperature gas effluents, the method comprising: (a) providing a porous substrate layer of zirconia; (b) providing a suspension of metal carbonate in a solvent; (c) introducing the suspension onto the surface of the porous substrate layer, wherein the solvent is drawn through the porous substrate layer which deposits the metal carbonate into the porous substrate layer; (d) drying the porous substrate layer to evaporate the solvent; and (e) calcinating the porous substrate layer, wherein the metal carbonate melts and reacts with the zirconia of the porous substrate layer to create metal zirconate, thereby producing a solid-state zirconate membrane.

In some embodiments, the solvent comprises ethanol.

In some embodiments, the amount of carbonate in the suspension is correlated with the porosity of the substrate layer.

In some embodiments, the amount of carbonate in the suspension is in excess of the amount of zirconia in the substrate layer.

Also provided is a hydroxide solution method of for producing a solid-state zirconate membrane for carbon dioxide separation from high-temperature gas effluents, the method comprising: (a) providing a porous substrate layer of zirconia; (b) providing a solution of metal hydroxide in a solvent; (c) submerging the porous substrate layer in the solution; (d) removing the porous substrate layer from the suspension and allowing the porous substrate layer to dry, which evaporates the solvent and deposits the metal hydroxide into the porous substrate layer; (e) repeating steps (c) to (d) until the porous substrate layer is saturated with metal hydroxide deposit; (f) heating the porous substrate layer in an atmosphere of carbon dioxide, wherein the metal hydroxide deposited in the porous substrate layer reacts with carbon dioxide to produce metal carbonate in the porous substrate layer; and (g) calcinating the porous substrate layer, wherein the metal carbonate melts and reacts with the zirconia of the porous substrate layer to create metal zirconate, thereby producing a solid-state zirconate membrane.

In some embodiments, the solvent comprises methanol and water.

In some embodiments, the porous substrate layer being saturated with metal hydroxide deposit of step (e) is indicated by the weight gain from metal hydroxide deposit in the porous substrate layer between each repetition approaching zero.

In some embodiments, the porous substrate layer of step (f) is heated in the atmosphere of carbon dioxide to about 200° C.

In some embodiments, the porous substrate layer of step (f) is heated in the atmosphere of carbon dioxide for about two hours.

In some embodiments that may be combined with any of the preceding, the metal is lithium, potassium, or a combination thereof.

In some embodiments, the metal comprises lithium and potassium, which have a molar ratio in a range of about 5:1 to about 15:1.

In some embodiments, the molar ratio of lithium to potassium of the metal is about 10:1.

In some embodiments in which the metal is lithium, which has a molar ratio to zirconia of the substrate layer in a range of about 2:1 to about 3:1, and/or wherein the metal is potassium, which has a molar ratio to the zirconia of the substrate layer in a range of about 0:1 to about 1:1.

In some embodiments in which the metal is lithium, which has a molar ratio to zirconia of the substrate layer about 2.5:1, and/or wherein the metal is potassium, which has a molar ratio to the zirconia of the substrate layer about 0.27:1.

In some embodiments that may be combined with any of the preceding, the porous substrate layer comprises yttrium stabilized zirconia (YSZ).

In some embodiments, the porous substrate layer is in the form or shape of a tube, a flat sheet, or a monolith.

In some embodiments that may be combined with any of the preceding, the calcinating comprises heating the porous substrate layer to a temperature between about 650° C. and about 850° C.

In some embodiments, the calcinating comprises heating the porous substrate layer to about 750° C.

In some embodiments that may be combined with any of the preceding, the method further comprises a step of rotating the porous substrate layer during calcination.

In some embodiments that may be combined with any of the preceding, the method further comprises a step of using the produced solid-state zirconate membrane to separate carbon dioxide from high-temperature gas effluents.

Further provided are solid-state zirconate membranes produced according to the method of any aforementioned embodiments.

Unless defined otherwise, the term “about”, particularly in reference to a given quantity, is meant to encompass deviations of plus or minus ten percent.

### BRIEF DESCRIPTION OF THE DRAWINGS

FIG. 1 illustrates the thermal dynamic reaction between lithium carbonate and zirconia to form lithium zirconate and carbon dioxide.

FIG. 2 illustrates the reaction pathway for lithium zirconate formation from hydroxide precursors, showing the intermediate carbonate formation step.

FIG. 3 shows the thermal gravimetric analysis (TGA) results for a solid-body lithium zirconate membrane, demonstrating CO₂ absorption and desorption characteristics at various temperatures.

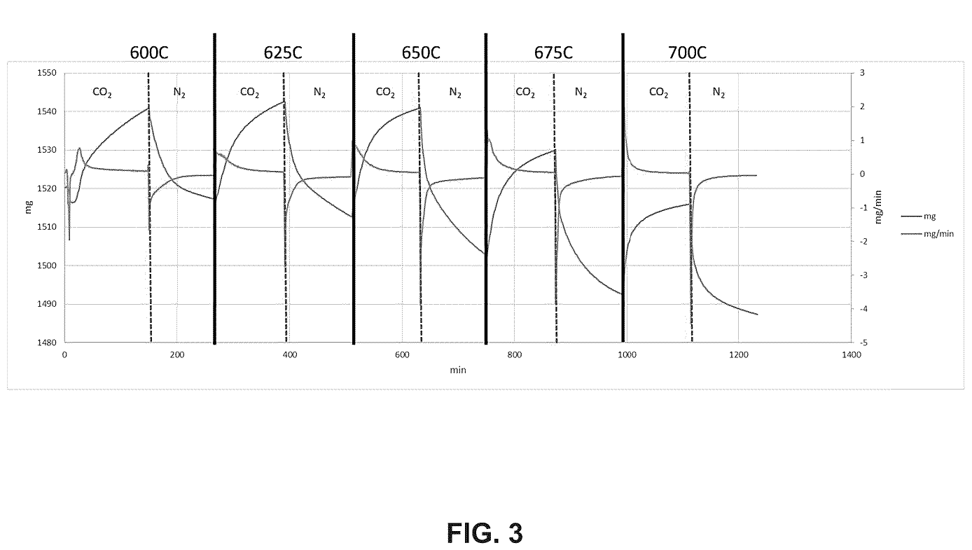

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown but are to be accorded the scope consistent with the claims.

The present disclosure provides detailed methods and compositions for manufacturing solid-state zirconate membranes suitable for high-temperature CO₂ separation. The methods described herein address the mechanical stability limitations of conventional LZO membranes while maintaining their desirable CO₂ separation properties.

The carbonate slurry method involves preparing a suspension of metal carbonates in an organic solvent, introducing this suspension onto a porous zirconia substrate, and allowing the solvent to draw the carbonates into the substrate pores. After drying, the substrate undergoes calcination where the carbonates react with the zirconia to form metal zirconate.

The hydroxide solution method involves repeatedly submerging a porous zirconia substrate in a metal hydroxide solution until saturation. The hydroxide-loaded substrate is then exposed to carbon dioxide at elevated temperature to form carbonates, followed by calcination to produce metal zirconate.

Both methods can utilize combinations of lithium and other metals (e.g., potassium) as the metal components, with specific molar ratios optimized for performance. The resulting membranes exhibit improved mechanical stability while maintaining high CO₂ selectivity.

### Carbonate Slurry Method

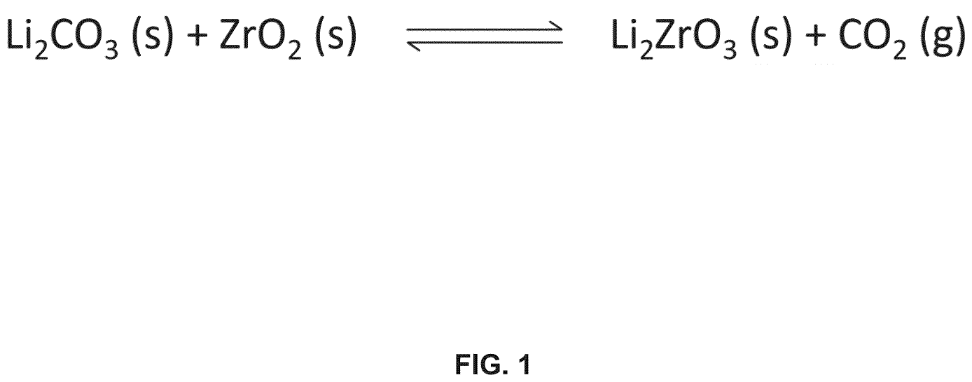

Lithium zirconate (LZO) can be prepared by the addition of lithium carbonate into a solid porous body of yttrium stabilized zirconia (YSZ) substrate after calcination at elevated temperatures as per the reaction in FIG. 1.

Additionally, other carbonates, such as potassium carbonate, can be included to promote eutectic mixtures with lower carbonate melting temperatures which can expand and enhance the lower range of CO₂ absorption/reaction of LZO to lower temperatures. Table 1 list the range of molar ratios of Li and K to Zr for the formation of LZO. The amount of carbonates added is dictated by the apparent porosity of the solid body YSZ. The carbonate-to-zirconia ratios are carefully controlled, with lithium having a molar ratio to zirconia between 2:1 and 3:1 (preferably 2.5:1), and potassium having a molar ratio between 0:1 and 1:1 (preferably 0.27:1). The amount of carbonate in the suspension is correlated with the substrate porosity and is typically provided in excess of the stoichiometric amount of zirconia.

TABLE 1
Formulation of exemplary metal molar
ratios with respect to zirconium.

| | Preferred | Range of |
|---|---|---|
| Metal | Molar Ratio | Molar Ratio |
| Zr | 1 | 1 |
| Li | 2.5 | 2 to 3 |
| K | 0.27 | 0 to 1 |

Specifically, by way of example, a slurry solution of lithium and potassium carbonate at the appropriate molar ratio is prepared in ethanol. The slurry is mixed to generate a homogenous solution. The solution is then poured into the inner diameter of the YSZ tube. The ethanol solvent is drawn through the substrate and a uniform layer of carbonate is deposited on the inner wall.

The ethanol is allowed to dry at room temperature and the substrate undergoes calcination at temperatures between 650° C. and 850° C. (preferably 750° C.). During calcination, the substrate may be continuously rotated to ensure uniform carbonate distribution and reaction.

Various forms or shapes may be used for the membrane, including, for example, tube, flat sheet, or monolith.

### Hydroxide Solution Method

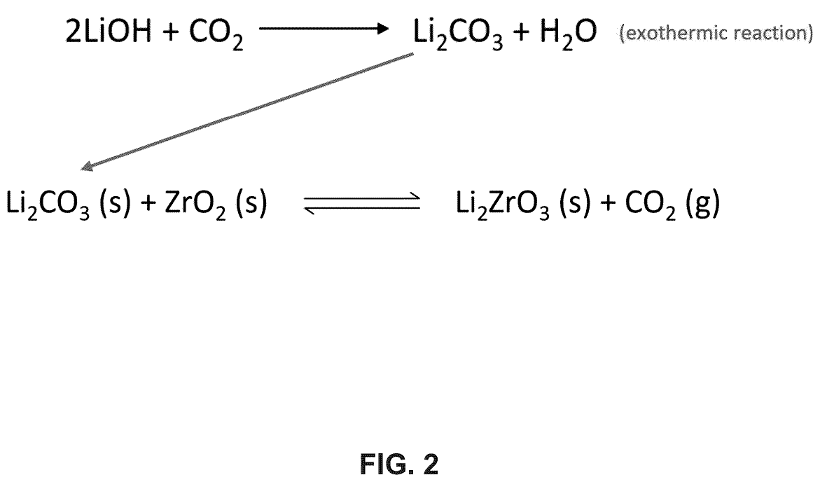

Lithium zirconate (LZO) can also be prepared by the addition of lithium hydroxide solution into a solid porous body of yttrium stabilized zirconia (YSZ) substrate. Accordingly, in another aspect, the disclosure provides a manufacturing process utilizing metal hydroxides as precursors. Upon exposure to carbon dioxide a thermal dynamic favored reaction producing lithium carbonate occurs. Upon calcination at elevated temperatures as per the reactions in FIG. 2, LZO is produced.

Specifically, by way of example, a hydroxide solution containing lithium hydroxide and optionally potassium hydroxide is prepared in methanol. A small amount of water is also added to completely dissolve the solid material. The ratio of lithium hydroxide to potassium hydroxide can be between 5:1 and 15:1, with 10:1 being preferred. The substrate to be infused is then submerged in the solution for a suitable period of time. The substate is removed, dried and then submerged again into the solution. This procedure is continued until mass gain approaches zero.

After the substrate has been saturated it is placed into sealed vessel under a pure carbon dioxide atmosphere. The vessel is then heated to 200 C and held at temperature for 2 hours. The sample is removed from the vessel and then calcined to 750° C. in air for several hours, during which the atmospheric CO₂ concentration is sufficient to convert the remaining hydroxides.

Similarly, the membrane may be in various forms or shapes, such as tube, flat sheet, or monolith, depending on the intended application.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

### EXAMPLES

The following examples are offered to illustrate provided embodiments and are not intended to limit the scope of the present disclosure.

### Example 1: Carbonate Slurry Method Implementation and Performance Testing

In this example, a tubular yttrium stabilized zirconia (YSZ) substrate was prepared with controlled porosity. A slurry containing Li₂CO₃ and K₂CO₃ in ethanol was prepared with a Li:K molar ratio of 10:1. The slurry was applied to the inner surface of the tube, and the ethanol was allowed to draw the carbonates into the porous structure. After drying, the tube was calcined at 750° C. while rotating, producing a uniform LZO membrane.

To measure and compare the absorption and desorption characteristics for the solid-body LZO formulations, samples were analyzed by thermal gravimetric analysis (TGA). TGA is a technique used to measure changes in the mass of a sample as it is heated, cooled, or held at a constant temperature. In the context of a solid body LZO membrane, TGA can help determine the absorption and desorption constants related to its behavior in processes like CO₂ capture. Table 2 lists the exemplary steps and parameters used for samples of ˜30 mg of LZO placed within an alumina or platinum cup for TGA. Steps 3-5 were repeated for elevated temperatures.

TABLE 2
Steps and parameters used for thermal gravimetric analysis (TGA).

| Steps and Parameters | Purge Gas |
|---|---|
| 1) Ramp to 900° C. at 20° C./min | CO₂ |
| 2) Equilibrate to 25° C. | CO₂ |
| 3) Ramp to 600° C. at 20° C./min | CO₂ |
| 4) Isotherm for 2 h | CO₂ |
| 5) Isotherm for 2 h | N₂ |

FIG. 2 shows the TGA results, in which the weight versus time, the derivative of weight versus time was plotted. The figure shows two key regions for each tested temperature: 1) absorption region, which occurs when the material gains mass, due to the uptake of CO₂ and was shown as an upward slope in the mass change curve; and 2) desorption region, which occurs when the material loses mass, due to the release of absorbed gases and was shown as a downward slope in the mass change curve. Data was extracted from this plot for the means of measuring the rate constants, which included the maximum rates in mg/min and mass in mg at those maximums for each isothermal step. Such data confirmed the functionality of the produced membranes.

### Example 2: Hydroxide Solution Method Implementation

In this example, a solution containing lithium hydroxide and potassium hydroxide (Li:K=10:1) was prepared in a mixture of methanol and water. A tubular yttrium stabilized zirconia (YSZ) substrate was prepared and repeatedly submerged in this solution, with drying steps between submersions, until the weight gain between cycles approaches zero, indicating saturation.

The hydroxide-loaded substrate was then placed in a sealed vessel under pure CO₂ at approximately 200° C. for two hours. This step converted the hydroxides to carbonates through an exothermic reaction.

Finally, the substrate underwent calcination at 750° C. in air to form the metal zirconate membrane.

TGA analysis was performed on the membrane samples. The membranes were tested at temperatures between 600° C. and 700° C. under alternating CO₂ and N₂ atmospheres. Results demonstrated consistent CO₂ absorption and desorption behavior, confirming the functionality of the membranes.

Taken together, these examples demonstrate successful implementation of using the disclosed methods and compositions to manufacture solid-state zirconate membrane for carbon dioxide separation from high-temperature gas effluents. TGA analysis confirmed successful formation of the LZO membranes with proper CO₂ absorption and desorption characteristics.

What is claimed is:

1. A method for producing a solid-state zirconate membrane for carbon dioxide separation from high-temperature gas effluents, the method comprising:
(a) providing a porous substrate layer of zirconia;
(b) providing a suspension of metal carbonate in a solvent;
(c) introducing the suspension onto the surface of the porous substrate layer, wherein the solvent is drawn through the porous substrate layer which deposits the metal carbonate into the porous substrate layer;
(d) drying the porous substrate layer to evaporate the solvent; and
(e) calcinating the porous substrate layer, wherein the metal carbonate melts and reacts with the zirconia of the porous substrate layer to create metal zirconate, thereby producing a solid-state zirconate membrane.

2. The method of claim 1, wherein the solvent comprises ethanol.

3. The method of claim 1, wherein the amount of carbonate in the suspension is correlated with the porosity of the substrate layer.

4. The method of claim 1, wherein the amount of carbonate in the suspension is in excess of the amount of zirconia in the substrate layer.

5. A method of for producing a solid-state zirconate membrane for carbon dioxide separation from high-temperature gas effluents, the method comprising:
(a) providing a porous substrate layer of zirconia;
(b) providing a solution of metal hydroxide in a solvent;
(c) submerging the porous substrate layer in the solution;
(d) removing the porous substrate layer from the suspension and allowing the porous substrate layer to dry, which evaporates the solvent and deposits the metal hydroxide into the porous substrate layer;
(e) repeating steps (c) to (d) until the porous substrate layer is saturated with metal hydroxide deposit;
(f) heating the porous substrate layer in an atmosphere of carbon dioxide, wherein the metal hydroxide deposited in the porous substrate layer reacts with carbon dioxide to produce metal carbonate in the porous substrate layer; and
(g) calcinating the porous substrate layer, wherein the metal carbonate melts and reacts with the zirconia of the porous substrate layer to create metal zirconate, thereby producing a solid-state zirconate membrane.

6. The method of claim 5, wherein the solvent comprises methanol and water.

7. The method of claim 5, wherein the porous substrate layer being saturated with metal hydroxide deposit of step (e) is indicated by the weight gain from metal hydroxide deposit in the porous substrate layer between each repetition approaching zero.

8. The method of claim 5, wherein the porous substrate layer of step (f) is heated in the atmosphere of carbon dioxide to about 200° C.

9. The method of claim 5, wherein the porous substrate layer of step (f) is heated in the atmosphere of carbon dioxide for about two hours.

10. The method of claim 5, wherein the metal is lithium, potassium, or a combination thereof.

11. The method of claim 10, wherein the metal comprises lithium and potassium, which have a molar ratio in a range of about 5:1 to about 15:1.

12. The method of claim 11, wherein the molar ratio of lithium to potassium of the metal is about 10:1.

13. The method of claim 10, wherein the metal is lithium, which has a molar ratio to zirconia of the substrate layer in a range of about 2:1 to about 3:1, and/or
wherein the metal is potassium, which has a molar ratio to the zirconia of the substrate layer in a range of about 0:1 to about 1:1.

14. The method of claim 13, wherein the metal is lithium, which has a molar ratio to zirconia of the substrate layer about 2.5:1, and/or
wherein the metal is potassium, which has a molar ratio to the zirconia of the substrate layer about 0.27:1.

15. The method of claim 1, wherein the porous substrate layer comprises yttrium stabilized zirconia (YSZ).

16. The method of claim 1, wherein the porous substrate layer is in the form or shape of a tube, a flat sheet, or a monolith.

17. The method of claim 1, wherein the calcinating comprises heating the porous substrate layer to a temperature between about 650° C. and about 850° C.

18. The method of claim 1, wherein the calcinating comprises heating the porous substrate layer to about 750° C.

19. The method of claim 1, further comprising rotating the porous substrate layer during calcination.

20. The method of claim 1, further comprising using the produced solid-state zirconate membrane to separate carbon dioxide from high-temperature gas effluents.

21. A solid-state zirconate membrane produced according to the method of claim 1.
